(19) United States
(12) Patent Application Publication
(10) Pub. No.: US 2015/0370021 A1
(43) Pub. Date: Dec. 24, 2015

(54) HIGH PORT DENSITY OPTICAL TRANSCEIVER MODULE

(71) Applicant: Avago Technologies General IP (Singapore) Pte. Ltd., Singapore (SG)

(72) Inventor: Seng-Kum Chan, Santa Clara, CA (US)

(21) Appl. No.: 14/313,834

(22) Filed: Jun. 24, 2014

(51) Int. Cl. G02B 6/42

(52) U.S. Cl. CPC G02B 6/4277; G02B 6/428; G02B 6/4214

(57) ABSTRACT

An optical communications module has two sub-housings that are pluggable into adjacent slots of an EMI cage. The module has a connector array of at least four optical connector ports configured to mate with at least four pluggable optical connectors. In the connector array, each pair of optical connector ports is immediately adjacent to at least one other pair.

### BACKGROUND

Optical data transceiver modules convert optical signals received via an optical fiber into electrical signals, and convert electrical signals into optical signals for transmission via an optical fiber. An optical data transceiver module can have one or more transmit and receive channels. Each channel is commonly associated with a single optical fiber. However, bidirectional transceiver modules that both transmit and receive optical signals over the same optical fiber are known. Other types of optical data communications modules are also known, such as optical transmitter modules that have only transmit channels and no receive channels, and optical receiver modules that have only receive channels and no transmit channels.

In a transmitter module or in the transmitter portion of a transceiver module, an opto-electronic light source such as a laser performs the electrical-to-optical signal conversion. In a receiver module or in the receiver portion of a transceiver module, an opto-electronic light detector such as a photodiode performs the optical-to-electrical signal conversion. A transceiver module commonly also includes optical elements, such as lenses, as well as electrical circuitry such as drivers and receivers. A transceiver module also includes one or more optical ports to which an optical fiber cable is connected. The light source, light detector, optical elements and electrical circuitry are mounted within a module housing. The one or more optical ports are located on the module housing.

Various types of optical ports are known, such as LC, SC, FC, etc. An LC optical connector port, for example, provides a latching engagement. When a user inserts or “plugs” an LC connector into an LC connector port, a resiliently biased tab on the connector body of the LC connector engages features of the LC connector port in the manner of a snap engagement. To release or disengage the LC connector from the LC connector port, a user presses and flexes the tab. Both simplex LC connectors, in which the end of a single fiber is retained in a single ferrule, and duplex LC connectors, in which two fibers are retained in two respective ferrules in a side-by-side configuration, are known.

Various transceiver module configurations are known. One family of transceiver module configurations or form factors is known as Small Form Factor Pluggable (SFP) and includes within this family such form factors as, for example, SFP+, quad SFP (QSFP), QSFP+, etc. Such SFP-family transceiver modules have in common an elongated housing having a substantially rectangular cross-sectional shape. A forward end of the housing can have up to two connector ports, such as, for example, LC connector ports. A rearward end of the housing has an array of electrical contacts that can be plugged into a mating connector when the rearward end is inserted or plugged into a server, computer, network switch, or other external device. Such an external device commonly includes a sheet metal enclosure, referred to as an electromagnetic interference (EMI) cage. Such an EMI cage includes one or more generally rectangular bays or slots configured to receive transceiver modules.

An example of a conventional EMI cage 10 having two slots 12 and 14 is shown in FIG. 1. However, EMI cages having arrays of more than two slots, such as four, eight, or even more slots are known. Regardless of the number of slots, the slots are commonly arranged in a rectangular array, with slots of a row or column separated from slots of an adjacent row or column by a sheet metal wall. For example, in EMI cage 10, slots 12 and 14 are arranged in a column, i.e., slot 12 is above and adjacent to slot 14. Slots 12 and 14 conform to a form factor standard in the SFP family, such as QSFP. That is, as shown in FIGS. 1-2, two conventional transceiver modules 16 and 18 that correspondingly conform to that form factor standard can be plugged into slots 12 and 14, respectively.

Transceiver module 16 has two LC connector ports 20 and 22 and a delatch tab 24. Similarly, transceiver module 18 has two LC connector ports 26 and 28 and a delatch tab 30. To plug, for example, transceiver module 16 into slot 12, the user inserts the rearward end of transceiver module 16 into the opening of slot 12 and slides transceiver module 16 into slot 12 until its array of electrical contacts engage a mating connector at the rearward end (not shown) of slot 12. When transceiver module 16 is fully inserted into slot 12, a latch mechanism in transceiver module 16 engages an engaging member (not shown) in slot 12 to prevent transceiver module 16 from being inadvertently removed from slot 12. To remove or unplug transceiver module 16 from slot 12, the user pulls delatch tab 24, which disengages the engaging member in slot 12. Transceiver module 18 can be plugged into and unplugged from slot 14 in the same manner

The LC connectors of fiber-optic cables (not shown) can be plugged into LC connector ports 20, 22, 26 and 28. LC connector ports 20 and 22 can be transmit and receive ports, respectively. Likewise, LC connector ports 26 and 28 can be transmit and receive ports, respectively.

### SUMMARY

Embodiments of the present invention relate to an optical communications module. In an exemplary embodiment, the optical communications module includes a module head at a housing first end, a first sub-housing, and a second sub-housing. The module head has a connector array of at least four optical connector ports configured to mate with at least four pluggable optical connectors. Each pair of optical connector ports is immediately adjacent to at least one other pair of optical connector ports. The first sub-housing has an elongated shape, extending between the housing first end and a housing second end. The first sub-housing is configured to be received within a first EMI cage slot. The second sub-housing similarly has an elongated shape, extending between the housing first end and the housing second end. The second sub-housing is configured to be received within a second EMI cage slot.

Other systems, methods, features, and advantages will be or become apparent to one with skill in the art upon examination of the following figures and detailed description. It is intended that all such additional systems, methods, features, and advantages be included within this description, be within the scope of the specification, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is perspective view of two conventional optical communications modules shown being plugged into a conventional EMI cage.

FIG. 2 is a side elevation view of the conventional optical communications modules and EMI cage of FIG. 1.

FIG. 3 is perspective view of an optical communications module in accordance with an exemplary embodiment of the invention.

FIG. 4 is a perspective view of the optical communications module of FIG. 3 plugged into a conventional EMI cage.

FIG. 5 is a front elevation view of the optical communications module of FIG. 3.

FIG. 6 is a rear perspective view of the optical communications module of FIG. 3 with top and bottom cover portions of the module housing removed to reveal portions of the module interior.

FIG. 7 is a left side elevation view of the electro-optical subassemblies of the optical communications module of FIG. 3.

FIG. 8 is a right side elevation view of the electro-optical subassemblies of the optical communications module of FIG. 3.

FIG. 9 is a generalized or diagrammatic front elevation view of the optical communications module of FIG. 3, showing the arrangement of opto-electronic light sources and light detectors in the electro-optical subassemblies.

FIG. 10 is a generalized or diagrammatic side elevation view of an opto-electronic light source and optics device, showing the optical transmit path.

FIG. 11 is a generalized or diagrammatic side elevation view of an opto-electronic light detector and optics device, showing the optical receive path.

### DETAILED DESCRIPTION

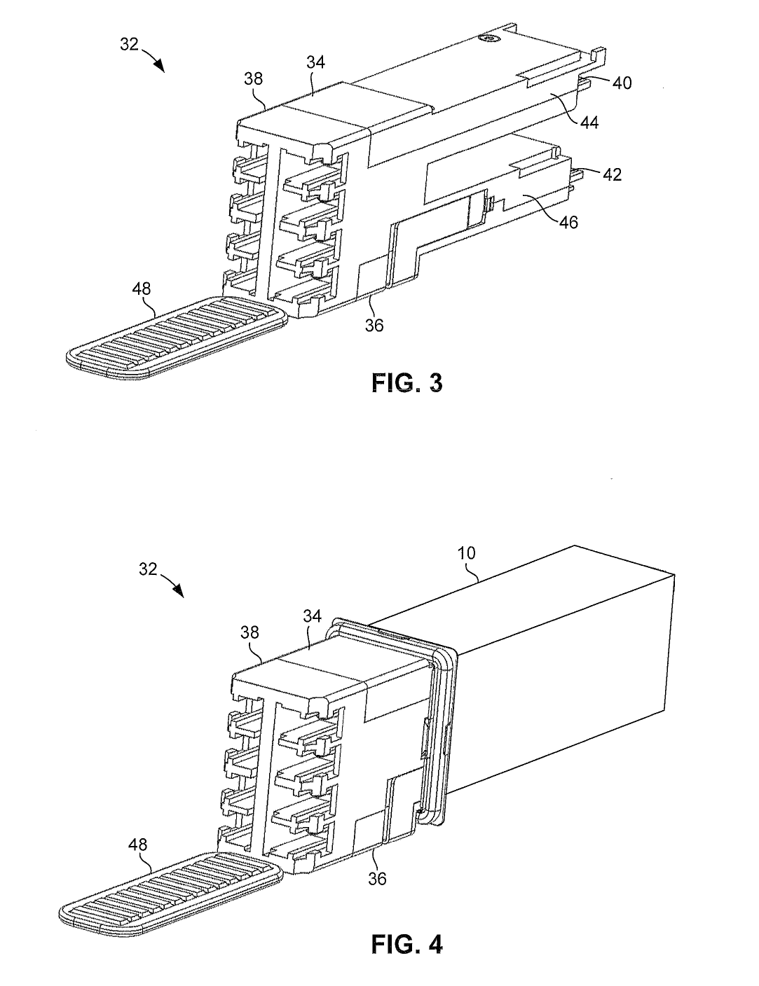

As illustrated in FIG. 3, in an illustrative or exemplary embodiment of the invention, an optical transceiver module 32 includes a module housing having a top cover portion 34, bottom cover portion 36, and a module head 38. Optical transceiver module 32 (or its housing) has an elongated shape, with module head 38 at one end of the module housing and electrical signal connections 40 and 42 at the opposite end of the module housing. The module housing includes a first sub-housing 44 and a second sub-housing 46 that extend substantially parallel. Top cover portion 34 covers a portion of first sub-housing 44. Similarly, bottom cover portion 36 covers a portion of second sub-housing 46.

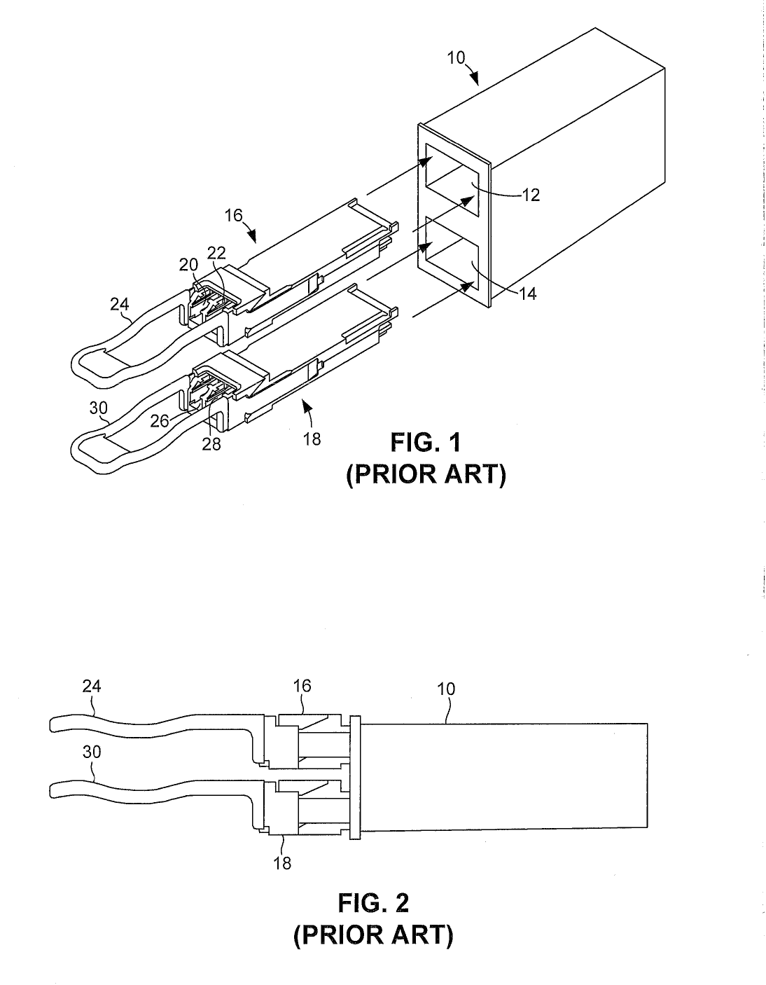

As illustrated in FIG. 4, optical transceiver module 32 can be plugged into a conventional EMI cage 10 (FIG. 1) or similar EMI cage having a rectangular array of bays or slots. More specifically, optical transceiver module 32 can be plugged into EMI cage 10 (FIG. 1) by plugging first sub-housing 44 into slot 12 and plugging second sub-housing 46 into slot 14. Note that first and second sub-housings 44 and 46 are spaced apart by a distance substantially equal to the distance that slots 12 and 14 are spaced apart. As first sub-housing 44 and second sub-housing 46 are each similar in size, shape and other characteristics (i.e., form factor) to a conventional form factor standard in the SFP family, such as QSFP, first sub-housing 44 and second sub-housing 46 are pluggable into slots 12 and 14.

Optical transceiver module 32 includes a delatch tab 48 and an associated delatch mechanism (not shown) that can be of essentially conventional structure and function. Thus, optical transceiver module 32 can be removed, i.e., unplugged, from slots 12 and 14 by pulling delatch tab 48. There is no more than one delatch tab 48.

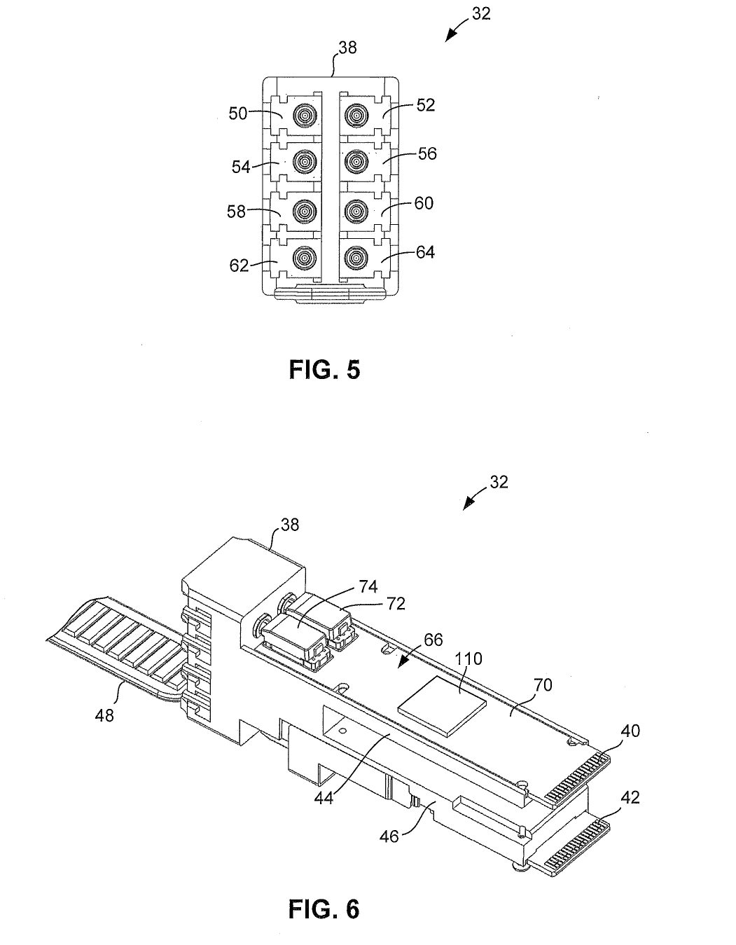

As illustrated in further detail in FIG. 5, in the exemplary embodiment module head 38 has an array of eight LC connector ports 50, 52, 54, 56, 58, 60, 62 and 64. Thus, although not shown for purposes of clarity, the LC connectors of up to eight corresponding fiber-optic cables can be plugged into LC connector ports 50-64. However, in other embodiments (not shown), such a module head can have an array of any other number of four or more such connector ports. Also, although in the exemplary embodiment they are of the LC type, in other embodiments such connector ports can be of any other suitable type, such as, for example, SC, FC, etc.

As described in further detail below, in the exemplary embodiment the pair of LC connector ports 50 and 52 are transmit and receive ports, respectively; the pair of LC connector ports 54 and 56 are transmit and receive ports, respectively, and are immediately adjacent the pair of LC connector ports 50 and 52; the pair of LC connector ports 58 and 60 are transmit and receive ports, respectively, and are immediately adjacent the pair of LC connector ports 54 and 56; and the pair of LC connector ports 62 and 64 are transmit and receive ports, respectively, and are immediately adjacent the pair of LC connector ports 58 and 60. Indeed, it can be noted that every pair of immediately adjacent LC connector ports 50-64 is immediately adjacent at least one other pair. (A reference to two “immediately adjacent” elements is used herein to refer to an absence of another, intervening one of such elements or other significant structure between the two.) It can also be noted that the plane in which LC connector ports 50-64 are arrayed defines a connector panel or 2×4 array of LC connector ports 50-64. The plane of this 2×4 array or connector panel is oriented normal to the longitudinal axis or direction of elongation of the module housing (i.e., sub-housings 44 and 46). Also, although in the exemplary embodiment LC connector ports 50, 54, 58 and 62 are transmit ports, and LC connector ports 52, 56, 60 and 64 are receive ports, in other embodiments any connector port in any location in the array can be either a transmit port or a receive port or even a bidirectional port.

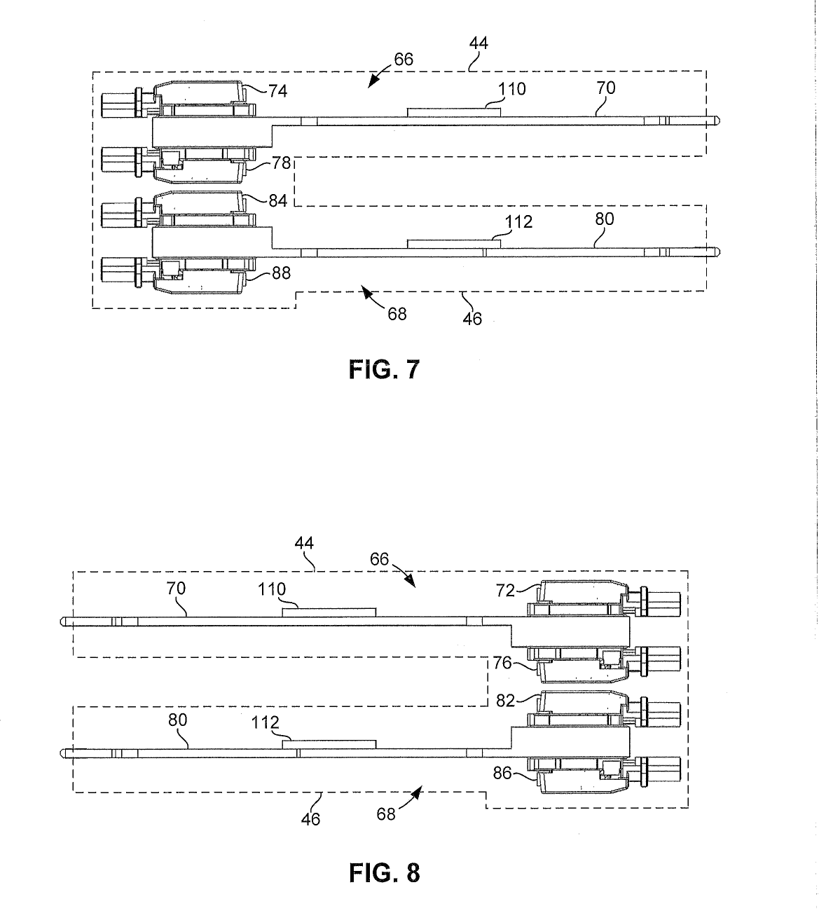

As illustrated in FIGS. 6-8, a first electro-optical subassembly 66 is essentially contained within first sub-housing 44, and a second electro-optical subassembly 68 (FIGS. 7-8) is essentially contained within second sub-housing 46. First electro-optical subassembly 66 includes a first printed circuit board (PCB) 70 as well as a first optics device 72 and second optics device 74 mounted on a first surface of first PCB 70 in a side-by-side arrangement. Electrical signal connections 40 (FIG. 3) are defined by an array of metalized regions or contact fingers on the surface of PCB 70.

First optics device 72 is optically coupled to LC connector port 50 (FIG. 5). That is, the ferrule end of first optics device 72 defines a portion of LC connector port 50 and is mateable with the LC connector of a fiber-optic cable (not shown) pluggable into LC connector port 50. Likewise, second optics device 74 is optically coupled to LC connector port 52 (FIG. 5). That is, the ferrule end of second optics device 74 defines a portion of LC connector port 52 and is mateable with the LC connector of a fiber-optic cable (not shown) pluggable into LC connector port 52.

First electro-optical subassembly 66 further includes a third optics device 76 (FIG. 8) mounted on a second surface of first PCB 70 and a fourth optics device 78 (FIG. 7) mounted on the second surface of first PCB 70 in a side-by-side arrangement. Third optics device 76 is optically coupled to LC connector port 54 (FIG. 5). That is, the ferrule end of third optics device 76 defines a portion of LC connector port 54 and is mateable with the LC connector of a fiber-optic cable (not shown) pluggable into LC connector port 50. Likewise, fourth optics device 78 is optically coupled to LC connector port 56 (FIG. 5). That is, the ferrule end of fourth optics device 78 defines a portion of LC connector port 56 and is mateable with the LC connector of a fiber-optic cable (not shown) pluggable into LC connector port 56. But for electrical signal connections 40 (FIG. 3) and the ferrule portions of optics devices 72-78, first electro-optical subassembly 66 is contained within first sub-housing 44.

Second electro-optical subassembly 68 includes a second PCB 80, a fifth optics device 82 (FIG. 8) and a sixth optics device 84 (FIG. 7) mounted in a side-by-side arrangement on a first surface of second PCB 80. Second electro-optical subassembly 68 further includes seventh optics device 86 (FIG. 8) and an eighth optics device 88 (FIG. 7) mounted in a side-by-side arrangement on a second surface of second PCB 80. Electrical signal connections 42 (FIG. 3) are defined by an array of metalized regions or contact fingers on the surface of PCB 80.

Fifth optics device 82 is optically coupled to LC connector port 58 (FIG. 5). That is, the ferrule end of fifth optics device 82 defines a portion of LC connector port 58 and is mateable with the LC connector of a fiber-optic cable (not shown) pluggable into LC connector port 58. Sixth optics device 84 is optically coupled to LC connector port 60 (FIG. 5). That is, the ferrule end of sixth optics device 84 defines a portion of LC connector port 60 and is mateable with the LC connector of a fiber-optic cable (not shown) pluggable into LC connector port 60. Seventh optics device 86 is optically coupled to LC connector port 62 (FIG. 5). That is, the ferrule end of seventh optics device 86 defines a portion of LC connector port 62 and is mateable with the LC connector of a fiber-optic cable (not shown) pluggable into LC connector port 62. Eighth optics device 88 is optically coupled to LC connector port 64 (FIG. 5). That is, the ferrule end of seventh optics device 88 defines a portion of LC connector port 64 and is mateable with the LC connector of a fiber-optic cable (not shown) pluggable into LC connector port 64. But for electrical signal connections 42 (FIG. 3) and the ferrule portions of optics devices 82-88, second electro-optical subassembly 68 is contained within second sub-housing 46.

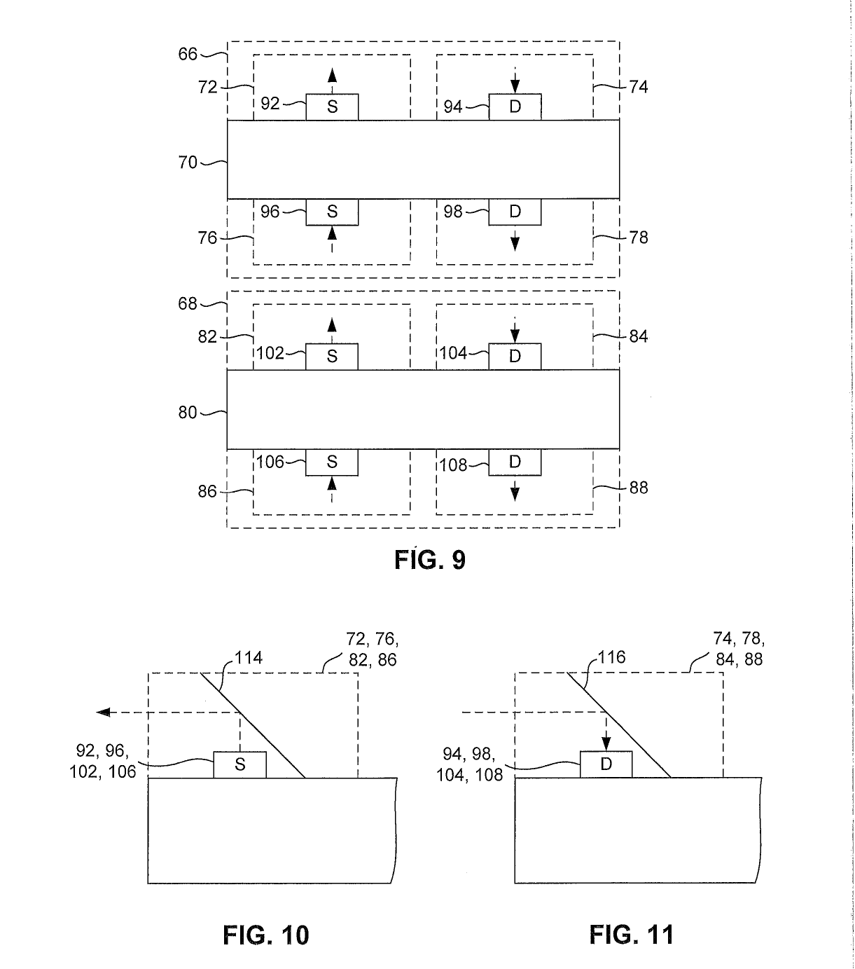

The arrangement of opto-electronic devices in first electro-optical subassembly 66 and second electro-optical subassembly 68 is illustrated in generalized or diagrammatic form in FIG. 9. As illustrated in FIG. 9, first electro-optical subassembly 66 and its electro-optical signal conversion system further include a first light source 92 (“S”) and a first light detector (“D”) 94 mounted on the first surface of first PCB 70 beneath first and second optics devices 72 and 74, respectively, and a second light source 96 and a second light detector 98 mounted on the second surface of first PCB 70 beneath third and fourth optics devices 76 and 78, respectively. Light sources 92 and 96 can be, for example, vertical cavity surface-emitting lasers (VCSELs) that convert electrical signals into optical signals. Light detectors 94 and 98 can be, for example, PIN photodiodes that convert optical signals into electrical signals. In other embodiments, other types of electrical-to-optical and optical-to-electrical signal conversion devices (i.e., opto-electronic devices) can be included instead of VCSELs and PIN photodiodes.

As further illustrated in FIG. 9, second electro-optical subassembly 68 and its electro-optical signal conversion system further include a third light source 102 and a third light detector 104 mounted on the first surface of second PCB 80 beneath fifth and sixth optics devices 82 and 84, respectively, and a fourth light source 106 and a fourth light detector 108 mounted on the second surface of second PCB 80 beneath seventh and eighth optics devices 86 and 88, respectively. Light sources 102 and 106 can be, for example, VCSELs, and light detectors 104 and 108 can be, for example, PIN photodiodes.

First electro-optical subassembly 66 further includes a signal processing integrated circuit (IC) 110 (FIGS. 7-8) mounted on first PCB 70. The electro-optical signal conversion system of first electro-optical subassembly 66 includes not only optics devices 72-78, light sources 92 and 96, and light detectors 94 and 98, but also a portion of the circuitry of signal processing IC 110 and signal interconnections among these elements. Signal processing IC 110 includes driver circuitry that drives light sources 92 and 96 in response to electrical signals received via electrical signal connections 40 (FIG. 6). Signal processing IC 110 also includes receiver circuitry that generates electrical signals by amplifying the outputs of light detectors 94 and 98. Such electrical signals are communicated between signal processing IC 110 and electrical signal connections 40 through traces, i.e., signal interconnections (not shown for purposes of clarity), in first PCB 70.

Second electro-optical subassembly 68 further includes another signal processing integrated circuit (IC) 112 (FIGS. 7-8) mounted on second PCB 80. The electro-optical signal conversion system of second electro-optical subassembly 68 includes not only optics devices 82-88, light sources 102 and 106, and light detectors 104 and 108, but also a portion of the circuitry of signal processing IC 112 and signal interconnections among these elements. Signal processing IC 112 includes driver circuitry that drives light sources 102 and 106 in response to electrical signals received via electrical signal connections 42 (FIG. 6). Signal processing IC 112 also includes receiver circuitry that generates electrical signals by amplifying the outputs of light detectors 104 and 108. Such electrical signals are communicated between signal processing IC 112 and electrical signal connections 42 through traces in second PCB 80.

As further illustrated in FIG. 10, each of optics devices 72, 76, 82 and 86 includes a reflective surface 114 or similar reflective element. Each of optics devices 72, 76, 82 and 86 is configured to direct optical signals, i.e., light beams, along an optical path (indicated as a broken-line arrow) between its ferrule portion and the respective one of light sources 92, 96, 102 and 106. More specifically, reflective surface 114 is configured to redirect light emitted by the respective one of light sources 92, 96, 102 and 106 at an angle of 90 degrees into the ferrule portion of the respective one optics devices 72, 76, 82 and 86. Although not illustrated for purposes of clarity, each of optics devices 72, 76, 82 and 86 can also include one or more lenses and other optical elements in the optical path. Portions of optics devices 72, 76, 82 and 86 can be made of an optically transparent plastic material through which the optical path passes. Reflective surface 114 can comprise, for example, a wall formed in the plastic material, a total internal reflection (TIR) lens formed in the plastic material, or other reflective optical element.

As further illustrated in FIG. 11, each of optics devices 74, 78, 84 and 88 includes a reflective surface 116 or similar reflective element. Each of optics devices 74, 78, 84 and 88 is configured to direct optical signals, i.e., light beams, along an optical path between its ferrule portion and the respective one of light detectors 94, 98, 104 and 108. More specifically, reflective surface 116 is configured to redirect light from the ferrule portion of the respective one of optics devices 74, 78, 84 and 88 at an angle of 90 degrees onto the respective one of light detectors 94, 98, 104 and 108. Optics devices 74, 78, 84 and 88 can be similar in structure to above-described optics devices 72, 76, 82 and 86.

To use optical transceiver module 32, a user can plug it into EMI cage 10 as described above with regard to FIG. 4. When optical transceiver module 32 is fully plugged into EMI cage 10, electrical signal connectors in slots 12 and 14 of EMI cage 10 make contact with electrical signal connections 40 and 42, respectively. Optical signals received via LC connector port 52 or 56 are converted to electrical signals by light detector 94 or 98, respectively, amplified or otherwise processed by circuitry in signal processing IC 110, and the resulting signals are output via some of electrical signal connections 40. Optical signals received via LC connector port 60 or 64 are converted to electrical signals by light detector 104 or 108, respectively, amplified or otherwise processed by circuitry in signal processing IC 112, and the resulting signals are output via some of electrical signal connections 42. Electrical signals received via electrical signal connections 40 and processed by driver circuitry in signal processing IC 110 are ultimately converted to optical signals by light source 92 or 96 and emitted via LC connector port 50 or 54, respectively. Electrical signals received via electrical signal connections 42 and processed by driver circuitry in signal processing IC 112 are ultimately converted to optical signals by light source 102 or 106 and emitted via LC connector port 58 or 62, respectively.

One or more illustrative embodiments of the invention have been described above. However, it is to be understood that the invention is defined by the appended claims and is not limited to the specific embodiments described.

What is claimed is:

1. An optical communications module, comprising:
a module housing having a module head at a housing first end, a first sub-housing, and a second sub-housing, the module head having a connector array of at least four optical connector ports configured to mate with at least four pluggable optical connectors, each pair of optical connector ports of the array being immediately adjacent to at least one other pair of optical connector ports of the array, the first sub-housing elongated between the housing first end and a housing second end and configured to be received within a first electromagnetic interference (EMI) cage slot, the second sub-housing elongated between the housing first end and the housing second end and configured to be received within a second EMI cage slot; and
an electro-optical subassembly within the module housing.

2. The optical communications module of claim 1, wherein the electro-optical subassembly comprises:
a first electro-optical subassembly within the first sub-housing, the first electro-optical subassembly having a first electro-optical signal conversion system optically coupled to at least a first pair of the optical connector ports and having a first module electrical signal connection at the housing second end configured to mate with a mating electrical signal connection in the first EMI cage slot; and
a second electro-optical subassembly within the second sub-housing, the second electro-optical subassembly having a second electro-optical signal conversion system optically coupled to at least a second pair of the optical connector ports and having a second module electrical signal connection at the housing second end configured to mate with a mating electrical signal connection in the second EMI cage slot.

3. The optical communications module of claim 2, wherein:
the first electro-optical subassembly comprises a first printed circuit board (PCB) having a first end adjacent the module head and a second end having a plurality of electrical contact pads defining the first module electrical signal connection; and
the second electro-optical subassembly comprises a second PCB having a first end adjacent the module head and a second end having a plurality of electrical contact pads defining the second module electrical signal connection.

4. The optical communications module of claim 3, wherein each of the first sub-housing and the second sub-housing has a form factor in the SFP family of form factors.

5. The optical communications module of claim 3, wherein the first electro-optical signal conversion system comprises an opto-electronic device selected from the group consisting of opto-electronic light source and opto-electronic light detector mounted on the first PCB.

6. The optical communications module of claim 5, wherein the first electro-optical signal conversion system comprises first and second opto-electronic devices, each selected from the group consisting of opto-electronic light source and opto-electronic light detector, mounted on the first PCB.

7. The optical communications module of claim 6, wherein the first electro-optical signal conversion system further comprises third and fourth opto-electronic devices, each selected from the group consisting of opto-electronic light source and opto-electronic light detector, mounted on the first PCB.

8. The optical communications module of claim 7, wherein:
the first and second opto-electronic devices are mounted on a first surface of the first PCB; and
the third and fourth opto-electronic devices are mounted on a second surface of the first PCB.

9. The optical communications module of claim 8, further comprising exactly one delatch pull tab.

10. The optical communications module of claim 8, wherein:
the first opto-electronic device is a laser;
the second opto-electronic device is a photodiode;
the third opto-electronic device is a laser; and
the fourth opto-electronic device is a photodiode.

11. The optical communications module of claim 10, wherein the first electro-optical signal conversion system further comprises:
a first optics device mounted on the first surface of the first PCB and configured to direct optical signals along a first optical signal path between the first opto-electronic device and a first optical connector port;
a second optics device mounted on the second surface of the first PCB and along a second optical path between the second opto-electronic device and a second optical connector port;
a third optics device mounted on the second surface of the first PCB and configured to direct optical signals along a third optical signal path between the third opto-electronic device and a third optical connector port; and
a fourth optics device mounted on the second surface of the first PCB and along a fourth optical path between the fourth opto-electronic device and a fourth optical connector port.

12. The optical communications module of claim 11, wherein:
the first optics device is configured to redirect the first optical signal path at an angle of substantially 90 degrees between the first opto-electronic device and the first optical connector port; and
the second optics device is configured to redirect the first optical signal path at an angle of substantially 90 degrees between the second opto-electronic device and the second optical connector port;
the third optics device is configured to redirect the third optical signal path at an angle of substantially 90 degrees between the third opto-electronic device and the third optical connector port; and
the fourth optics device is configured to redirect the fourth optical signal path at an angle of substantially 90 degrees between the fourth opto-electronic device and the fourth optical connector port.

13. The optical communications module of claim 12, wherein each of the first through fourth optical connector ports is an LC port.

14. The optical communications module of claim 12, wherein the second electro-optical signal conversion system comprises an opto-electronic device selected from the group consisting of opto-electronic light source and opto-electronic light detector mounted on the second PCB.

15. The optical communications module of claim 14, wherein the second electro-optical signal conversion system comprises fifth and sixth opto-electronic devices, each selected from the group consisting of opto-electronic light source and opto-electronic light detector, mounted on the second PCB.

16. The optical communications module of claim 15, wherein the second electro-optical signal conversion system further comprises seventh and eighth opto-electronic devices, each selected from the group consisting of opto-electronic light source and opto-electronic light detector, mounted on the second PCB.

17. The optical communications module of claim 16, wherein:
the fifth and sixth opto-electronic devices are mounted on a first surface of the second PCB; and
the seventh and eighth opto-electronic devices are mounted on a second surface of the second PCB.

18. The optical communications module of claim 17, further comprising exactly one delatch pull tab.

19. The optical communications module of claim 17, wherein:
the fifth opto-electronic device is a laser;
the sixth opto-electronic device is a photodiode;
the seventh opto-electronic device is a laser; and
the eighth opto-electronic device is a photodiode.

20. The optical communications module of claim 19, wherein the second electro-optical signal conversion system further comprises:
a fifth optics device mounted on the first surface of the second PCB and configured to direct optical signals along a fifth optical signal path between the fifth opto-electronic device and a fifth optical connector port;
a sixth optics device mounted on the first surface of the second PCB and along a sixth optical path between the sixth opto-electronic device and a sixth optical connector port;
a seventh optics device mounted on the second surface of the second PCB and along a sixth optical path between the sixth opto-electronic device and a sixth optical connector port; and
an eighth optics device mounted on the second surface of the second PCB and along an eighth optical path between the eighth opto-electronic device and an eighth optical connector port.

21. The optical communications module of claim 20, wherein:
the fifth optics device is configured to redirect the fifth optical signal path at an angle of substantially 90 degrees between the fifth opto-electronic device and the fifth optical connector port; and
the sixth optics device is configured to redirect the sixth optical signal path at an angle of substantially 90 degrees between the sixth opto-electronic device and the sixth optical connector port;
the seventh optics device is configured to redirect the seventh optical signal path at an angle of substantially 90 degrees between the seventh opto-electronic device and the seventh optical connector port; and
the eighth optics device is configured to redirect the eighth optical signal path at an angle of substantially 90 degrees between the eighth opto-electronic device and the eighth optical connector port.

22. The optical communications module of claim 20, wherein each of the fifth through eighth optical connector ports is an LC port.

23. An optical communications module, comprising:
a module housing having a module head at a housing first end, a first sub-housing, and a second sub-housing, the module head having a connector array of at least four LC connector ports configured to mate with at least four LC connectors, each pair of LC connector ports of the array being immediately adjacent to at least one other pair of LC connector ports of the array, the first sub-housing elongated between the housing first end and a housing second end and configured to be received within a first electromagnetic interference (EMI) cage slot, the second sub-housing elongated between the housing first end and the housing second end and configured to be received within a second EMI cage slot; and
a first electro-optical subassembly essentially contained within the first sub-housing, the first electro-optical subassembly having a first electro-optical signal conversion system optically coupled to at least a first pair of the LC connector ports and having a first module electrical signal connection at the housing second end configured to mate with a mating electrical signal connection in the first EMI cage slot; and
a second electro-optical subassembly essentially contained within the second sub-housing, the second electro-optical subassembly having a second electro-optical signal conversion system optically coupled to at least a second pair of the LC connector ports and having a second module electrical signal connection at the housing second end configured to mate with a mating electrical signal connection in the second EMI cage slot.
